(19) United States
(12) Patent Application Publication
(10) Pub. No.: US 2024/0079696 A1
(43) Pub. Date: Mar. 7, 2024

(54) MANUFACTURING METHOD FOR POWER STORAGE DEVICE

(71) Applicant: Prime Planet Energy & Solutions, Inc., Tokyo (JP)

(72) Inventor: Haruhiko YAMAMOTO, Nisshin-shi (JP)

(21) Appl. No.: 18/352,245

(22) Filed: Jul. 14, 2023

(30) Foreign Application Priority Data
Sep. 5, 2022 (JP) 2022-140739

(51) Int. Cl. H01M 50/169; H01M 10/04

(52) U.S. Cl. CPC H01M 50/169; H01M 10/049; H01M 50/159

(57) ABSTRACT

A power storage device manufacturing method is provided. A closing plate used in a closing process includes an outer peripheral edge portion of a rectangular annular shape, which includes a pair of closing long-side portions arranged in parallel to each other, a pair of closing short-side portions arranged in parallel to each other, and four closing corner portions of circular arcuate shape connecting the long-side portions and the short-side portions. The outer peripheral edge portion further includes an outer circumferential end face located on an outermost side of an outer circumferential surface of the closing plate extending in parallel to a thickwise direction of the closing plate. In the outer circumferential end face, a length of a corner-portion end face included in the closing corner portion is shorter in the thickwise direction than a length of a long-side end face included in a closing long-side portion.

### CROSS-REFERENCE TO RELATED APPLICATIONS

This application is based upon and claims the benefit of priority from the prior Japanese Patent Application No. 2022-140739 filed on Sep. 5, 2022, the entire contents of which are incorporated herein by reference.

### BACKGROUND

### Technical Field

The present disclosure relates to a manufacturing method for a power storage device.

### Related Art

Japanese patent application publication No. 2012-079476 has disclosed a power storage device including an electrode body, a metal-made case for housing the electrode body, and a rectangular metal-made closing plate which is to be inserted in a rectangular opening of the case for closing the opening. In this power storage device, an opening wall portion surrounding the opening of the case and an outer peripheral edge portion of the closing plate are welded over entire circumferences.

The above-mentioned power storage device is manufactured as below. Firstly, in a closing process, the electrode body is housed inside the case and the closing plate is inserted in the opening of the case to close the opening. Subsequently, in a welding process, the outer peripheral edge portion of the closing plate and the opening wall portion of the case are laser-welded over the entire circumferences while the opening of the case has been closed by the closing plate.

The opening wall portion of the case used in the closing process is of a rectangular annular shape and formed of a pair of opening long-side portions arranged in parallel to each other, a pair of opening short-side portions arranged in parallel to each other, and four circular-arcuate opening corner portions connecting the opening long-side portions and the opening short-side portions. Further, the closing plate as explained below is also used in the closing process. Specifically, an outer peripheral edge portion of the closing plate is of a rectangular annular shape and formed of a pair of closing long-side portions arranged in parallel to each other, a pair of closing short-side portions arranged in parallel to each other, and four circular-arcuate closing corner portions connecting the closing long-side portions and the closing short-side portions. Further, an outer circumferential end face located on an outermost side of the outer circumferential surface of the closing plate is formed in parallel to a thickwise direction of the closing plate.

### SUMMARY

### Technical Problems

Herein, when the closing plate and the case, which are formed as mentioned above, are used in the closing process, insertion of the closing plate into the opening of the case could bring about “shaving” on the closing corner portions of the closing plate. This “shaving” of the closing corner portion represents a shaven state of a part of the closing corner portions (specifically, a portion overlapped with the opening corner portion in the thickwise direction), which is caused by insertion of the closing plate into the opening of the case such that a part of the closing corner portion of the closing plate is overlapped on the opening corner portion of the case when the closing plate is to be inserted into the opening of the case. This shaving of the closing corner portion generates metal powder and this metal powder is piled on a surface of the closing corner portion and on a surface of the opening corner portion.

To be specific, one example is a case that a short-side dimension of an inner circumferential surface of the opening wall portion of the case and a short-side dimension of the closing plate are similar (substantially the same) and a long-side dimension of the inner circumferential surface of the opening wall portion of the case and a long-side dimension of the closing plate are also similar (substantially the same), and further an outer radius of the closing corner portion of the closing plate is smaller than an inner radius of the opening corner portion of the case. In this case, in the closing process, the closing plate is inserted in the opening of the case such that a part of the closing corner portion of the closing plate is overlapped on the opening corner portion of the case in the thick wise direction. Thus, a part of the closing corner portion of the closing plate (specifically, a part overlapped on the opening wall portion of the case in the thickwise direction) is shaven, and thus the metal powder is generated.

As mentioned above, the metal powder generated by the shaving of the closing corner portion is piled on the surface of the closing corner portion and on the surface of the opening corner portion. Accordingly, this metal powder could cause generation of spatters and voids in the welding process after the closing process to laser-weld the outer peripheral edge portion of the closing plate and the opening wall portion of the case over the entire circumferences.

The present disclosure has been made in view of the above circumstances and has a purpose of providing a manufacturing method for a power storage device that achieves reduction in an amount of shaving of closing corner portion (namely, a volume of the shaven closing corner portion) as compared with a conventional art even when “the shaving of the closing corner portion” has occurred in the closing process.

### Means of Solving the Problems

(1) One aspect of the present disclosure is a manufacturing method for a power storage device, which comprises an electrode body, a case made of metal for housing the electrode body, and a closing plate made of metal and formed to be of a rectangular shape, which is to be inserted in a rectangular opening of the case for closing the opening, the power storage device being welded over entire circumferences of an opening wall portion of the case surrounding the opening and an outer peripheral edge portion of the closing plate, wherein the method includes: closing to close the opening by the closing plate in a manner that the electrode body is housed inside the case and the closing plate is inserted into the opening of the case; and welding to laser-weld the outer peripheral edge portion of the closing plate and the opening wall portion of the case over the entire circumferences in a state where the opening of the case has been closed by the closing plate, the opening wall portion of the case used for the closing is of a rectangular annular shape and includes a pair of opening long-side portions arranged in parallel to each other, a pair of opening short-side portions arranged in parallel to each other, and four opening corner portions of arcuate circular shape connecting the opening long-side portions and the opening short-side portions, the closing plate used for the closing is configured such that: the outer peripheral edge portion is of a rectangular annular shape and includes a pair of closing long-side portions arranged in parallel to each other, a pair of closing short-side portions arranged in parallel to each other, and four closing corner portions of arcuate circular shape connecting the closing long-side portions and the closing short-side portions; an outer circumferential end face positioned on an outermost side of an outer circumferential surface of the closing plate is formed to extend in parallel to a thickwise direction of the closing plate; and when a length in the thickwise direction of a corner-portion end face included in each of the closing corner portions is represented as LK and a length in the thickwise direction of a long-side end face included in each of the closing long-side portions is represented as LL, the length LK is shorter than the length LL.

In this manufacturing method, the closing plate as explained below is used for the process of the closing to close the opening by inserting the closing plate into the opening of the case. Specifically, the outer peripheral edge portion of the closing plate is of a rectangular annular shape and includes a pair of the closing long-side portions arranged in parallel to each other, a pair of the closing short-side portions arranged in parallel to each other, and the four closing corner portions of circular arcuate shape connecting the closing long-side portions and the closing short-side portions. Further, the outer circumferential end face positioned on an outermost side of the outer circumferential surface of the closing plate is formed to extend in parallel to the thickwise direction of the closing plate. Then, the length LK in the thickwise direction of a portion (hereinafter, referred as a corner-portion end face) of the outer circumferential end face included in the closing corner portion is shorter than the length LL in the thickwise direction of a portion (hereinafter, referred as a long-side end face) of the outer circumferential end face included in the closing long-side portion. Namely, a relation of LK<LL is satisfied.

Thus, in the process of the closing, even if there is occurred “shaving in the closing corner portion” in inserting the closing plate into the opening of the case, a shaven amount of the closing corner portion (namely, a volume of the shaven closing corner portion) can be reduced as compared with the conventional art where the relation LK=LL is satisfied. Therefore, an amount of metal powder which is generated by shaving of the closing corner portion can be reduced, and accordingly, an amount of metal powder to be piled on the surface of the outer peripheral edge portion of the closing plate and on the surface of the opening wall portion of the case can be reduced. This reduction further achieves reduction in generation of spatters and voids which are caused by metal powder in the process of the welding when the outer peripheral edge portion of the closing plate and the opening wall portion of the case are laser-welded over their entire circumferences after the process of the closing.

Herein, the “shaving” of the closing corner portion occurs when the closing plate is to be inserted in the opening of the case in a manner that a part of the closing corner portion of the closing plate is overlapped in the thickwise direction on the opening corner portion of the case, which causes shaving of the part of the closing corner portion (specifically, an overlapped portion overlapped on the opening corner portion in the thickwise direction). This shaving of the closing corner portion generates the metal powder, and the thus generated metal powder is piled on the surface of the closing corner portion and on the surface of the opening corner portion.

(2) Further preferably, in the manufacturing method for the power storage device according to the above (1), the closing plate used for the closing is configured such that: the closing plate has a front face facing one side in the thickwise direction and a rear face facing the other side in the thickwise direction; a portion located on a rear face side of the outer peripheral edge portion is chamfered over an entire circumference; the closing corner portions are chamfered more largely than the closing long-side portions to make the length LK shorter than the length LL; and the closing is to insert the closing plate into the opening of the case from the side of the rear face.

In this manufacturing method, the closing plate as explained below is used for the process of the closing to insert the closing plate into the opening of the case. The outer peripheral edge portion of the closing plate is chamfered over the entire circumference on a rear face side. Specifically, the closing corner portion is chamfered more largely than the closing long-side portion to make the length LK shorter than the length LL. The outer circumferential surface of the closing plate is configured with the above-mentioned outer circumferential end face and a surface of a chamfered portion. In the process of the closing, the closing plate is inserted in the opening of the case from the rear face side (namely, from a chamfered side), so that the shaven amount of the closing corner portion can be reduced.

(3) Further preferably, in the manufacturing method for the power storage device of the above-mentioned (1) or (2), when a length in the thickwise direction of a short-side end face included in each of the closing short-side portions in the outer circumferential end face is represented as LS, the closing plate used for the closing satisfies a relation of a length LS and the length LL represented as LS≤LL.

Herein, the opening long-side portion of the case is more easily elastically deformed than the opening corner portion. Accordingly, in the process of the closing, even if the closing plate starts to be inserted into the opening of the case in a positional relation where a part of the closing long-side portion of the closing plate overlaps the opening long-side portion of the case in the thickwise direction, the opening long-side portion is elastically deformed outwardly along the closing long-side portion while the closing long-side portion is coming to contact with the opening long-side portion. By this elastic deformation of the opening long-side portion, the closing plate can be inserted into the opening of the case such that the closing long-side portion is not overlapped on the opening long-side portion in the thickwise direction. Thereby, the “shaving” in the closing long-side portion can be restrained.

Further, the opening short-side portion of the case is more easily elastically deformed than the opening corner portion. Accordingly, the closing short-side portion of the closing plate is harder to generate the “shaving” than the closing corner portion. However, the opening short-side portion of the case is harder to be elastically deformed than the opening long-side portion, and thus the closing short-side portion of the closing plate is more likely to cause the “shaving” than the closing long-side portion. To address this, it is preferable to arrange the relation satisfying LS≤LL. Therefore, even if the “shaving” has occurred on the closing short-side portion in inserting the closing plate into the opening of the case, this arrangement makes it possible to reduce the amount of shaving on the closing short-side portion as similar to or less than the amount of shaving on the closing long-side portion as compared with a conventional art which is arranged as LS=LL.

Herein, the “shaving” in the present application represents a shaven state of an overlapped portion of the outer peripheral edge portion of the closing plate overlapped on the opening wall portion in the thickwise direction, and this shaving is caused in a manner that the closing plate is inserted into the opening of the case such that at least a part of the outer peripheral edge portion of the closing plate is overlapped on at least a part of the opening wall portion of the case in the thickwise direction in the process of the closing. This “shaving” generates the metal powder, and the thus generated metal powder is piled on the surface of the outer peripheral edge portion and on the surface of the opening wall portion.

### BRIEF DESCRIPTION OF THE DRAWINGS

FIG. 1 is a plan view (i.e., a top view) of a power storage device in an embodiment;

FIG. 2 is a sectional view taken along a line B-B in FIG. 1;

FIG. 3 is a plan view of a closing plate in the embodiment;

FIG. 4 is a sectional view taken along a line C-C, a line D-D, a line E-E, and a line F-F in FIG. 3;

FIG. 5 is a sectional view taken along a line G-G in FIG. 3;

FIG. 6 is a sectional view taken along a line H-H in FIG. 3;

FIG. 7 is a plan view of a case in the embodiment;

FIG. 8 is a front view of the case;

FIG. 9 is an explanatory view of a closing process in the embodiment;

FIG. 10 is another explanatory view of the closing process;

FIG. 11 is an enlarged view of a part J in FIG. 10;

FIG. 12 is a sectional view taken along a line K-K in FIG. 11;

FIG. 13 is another explanatory view of the closing process; and

FIG. 14 is an explanatory view of a welding process in the embodiment.

### DETAILED DESCRIPTION OF THE EXEMPLARY EMBODIMENTS

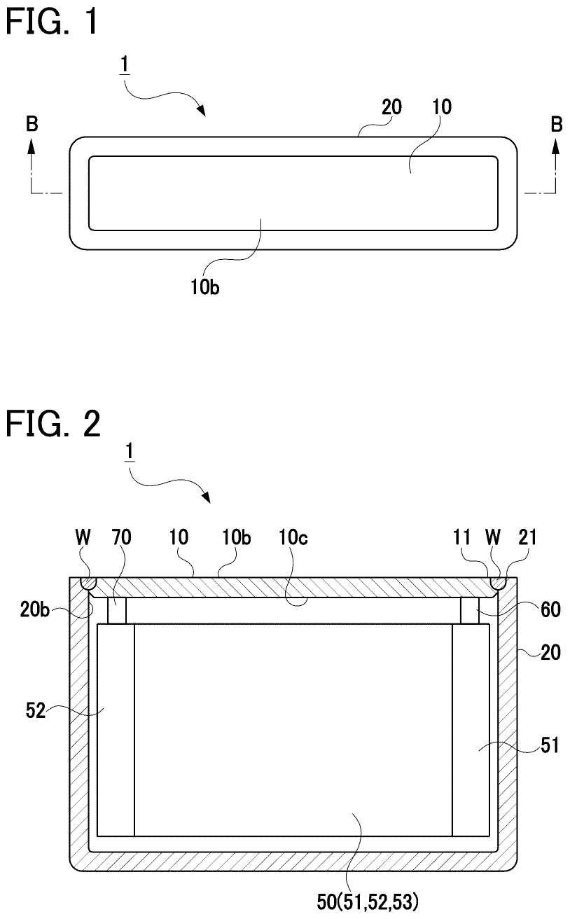

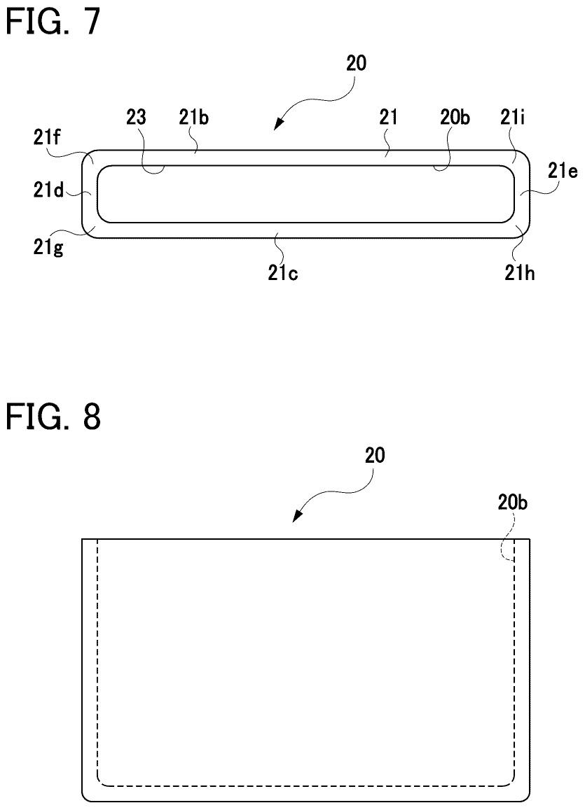

An embodiment of the present disclosure is explained. A power storage device 1 of the present embodiment is a lithium-ion secondary battery. This power storage device 1 is provided with an electrode body 50, a case 20 for housing the electrode body 50, and a closing plate 10 for closing an opening 20b of the case 20 (see FIG. 1 and FIG. 2). The case 20 is a metal-made hard case of a rectangular-parallelepiped box-like shape and is provided with the opening 20b of a rectangular shape (see FIG. 7 and FIG. 8). The closing plate 10 is of a rectangular shape and made of metal, and this closing plate 10 is to be inserted into the opening 20b of the case 20 to close the opening 20b (see FIG. 1 and FIG. 2).

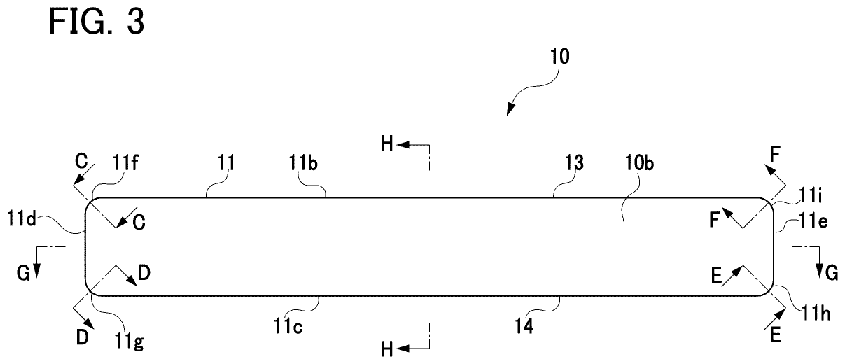

An opening wall portion 21 of the case 20 and an outer peripheral edge portion 11 of the closing plate 10 are welded over entire circumferences to form an annular welded portion W (see FIG. 2). Herein, the opening wall portion 21 of the case 20 is of a rectangular annular shape in planar view and is a portion surrounding the opening 20b of the case 20 (see FIG. 7). Further, the outer peripheral edge portion 11 of the closing plate 10 is a portion including an outer circumferential surface 13 of the closing plate 10 and is of a rectangular annular shape in planar view (see FIG. 3 to FIG. 6).

The electrode body 50 includes a positive electrode plate 51, a negative electrode plate 52, and a separator 53 interposed between the positive electrode plate 51 and the negative electrode plate 52 (see FIG. 2). To be more specific, the electrode body 50 is a flat-wound electrode body formed in a manner that the strip-shaped positive electrode plate 51, the strip-shaped negative electrode plate 52, and the strip-shaped separator 53 are provided and that the positive electrode plate 51 and the negative electrode plate 52 are wound with the separator 53 interposed therebetween. Inside the electrode body 50, a not-shown electrolytic solution is included. The not-shown electrolytic solution is housed also on a bottom face side inside the case 20.

Further, the power storage device 1 includes a positive current collecting member 60 to be connected to the positive electrode plate 51 of the electrode body 50 and a negative current collecting member 70 to be connected to the negative electrode plate 52 of the electrode body 50 (see FIG. 2). The power storage device 1 further includes a positive electrode terminal member (not shown) connected to the positive current collecting member 60 and exposed outside the power storage device 1 through a first through hole (not shown) formed in the closing plate 10. Furthermore, the power storage device 1 includes a negative electrode terminal member (not shown) connected to the negative current collecting member 70 and exposed outside the power storage device 1 through a second through hole (not shown) formed in the closing plate 10.

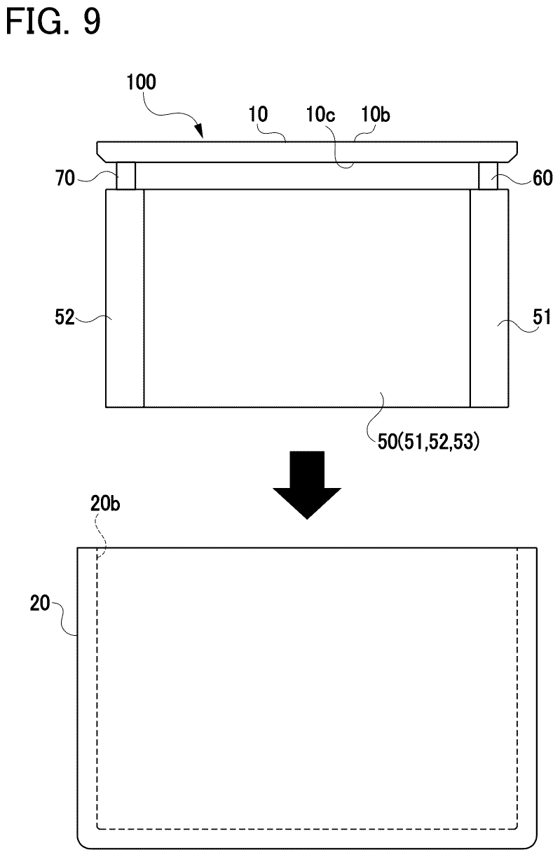

Next, a manufacturing method for the power storage device 1 of the present embodiment is explained. Firstly, a lid structure 100 is formed. To be specific, the positive current collecting member 60, the negative current collecting member 70, the positive electrode terminal member (not shown), and the negative electrode terminal member (not shown) are assembled to the closing plate 10 and integrated to form the lid structure 100. The electrode body 50 is then prepared. The positive electrode plate 51 of this electrode body 50 is connected with the positive current collecting member 60 of the lid structure 100, and the negative electrode plate 52 of the electrode body 50 is connected with the negative current collecting member 70 of the lid structure 100 to integrate the lid structure 100 and the electrode body 50 (see FIG. 9).

Subsequently, in the closing process, the electrode body 50 integrated with the lid structure 100 is housed inside the case 20 through the opening 20b and the closing plate 10 is inserted into the opening 20b of the case 20 so that the opening 20b of the case 20 is closed by the closing plate 10 (see FIG. 9). The closing plate 10 is inserted in the opening 20b of the case 20 from a rear face 10c side thereof. The opening wall portion 21 of the case 20 used for the closing process is of a rectangular annular shape and is provided with a pair of opening long-side portions 21b and 21c which are arranged in parallel to each other, a pair of opening short-side portions 21d and 21e which are arranged in parallel to each other, and four circular arcuate opening corner portions 21f, 21g, 21h, and 21i connecting the long-side portions and the short-side portions (see FIG. 7). The opening corner portion 21f is a portion for connecting the opening long-side portion 21b and the opening short-side portion 21d. The opening corner portion 21g is a portion for connecting the opening long-side portion 21c and the opening short-side portion 21d. The opening corner portion 21h is a portion for connecting the opening long-side portion 21c and the opening short-side portion 21e. The opening corner portion 21i is a portion for connecting the opening long-side portion 21b and the opening short-side portion 21e.

The closing plate 10 used for the closing process has the following configuration. Specifically, the outer peripheral edge portion 11 of the closing plate 10 is of a rectangular annular shape and is provided with a pair of closing long-side portions 11b and 11c which are arranged in parallel to each other, a pair of closing short-side portions 11d and 11e which are arranged in parallel to each other, and four circular arcuate closing corner portions 11f, 11g, 11h, and 11i connecting the long-side portions and the short-side portions (see FIG. 3 to FIG. 6). The closing corner portion 11f is a portion for connecting the closing long-side portion 11b and the closing short-side portion 11d. The closing corner portion 11g is a portion for connecting the closing long-side portion 11c and the closing short-side portion 11d. The closing corner portion 11h is a portion for connecting the closing long-side portion 11c and the closing short-side portion 11e. The closing corner portion 11i is a portion for connecting the closing long-side portion 11b and the closing short-side portion 11e. Further, an outer circumferential end face 14 located on an outermost side of the outer circumferential surface 13 of the closing plate 10 is formed to extend in parallel to a thickwise direction DT of the closing plate 10 (see FIG. 3 to FIG. 6). Herein, the outer circumferential surface 13 of the closing plate 10 is configured with the outer circumferential end face 14 and a surface of a chamfered portion 15 explained below.

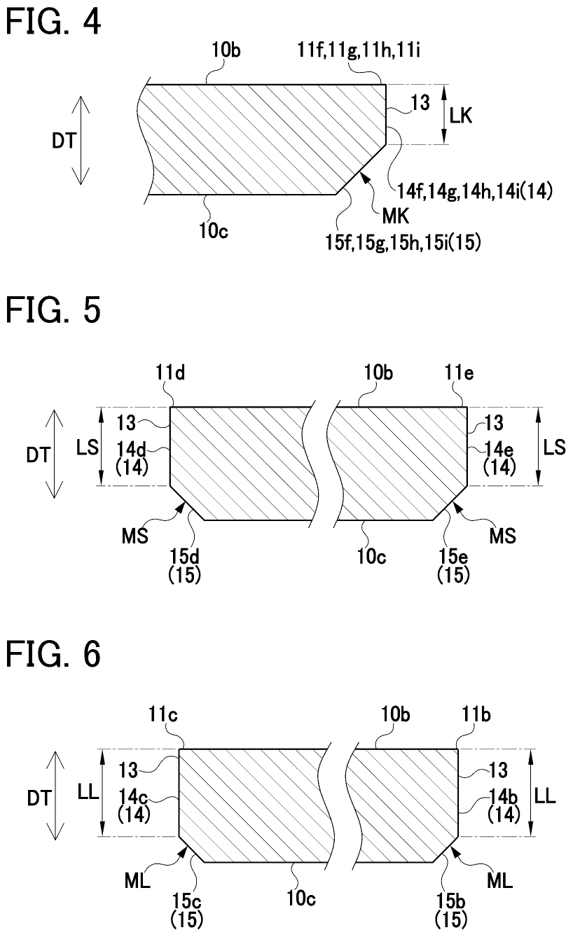

Herein, in the outer circumferential end face 14, a face included in the closing long-side portion 11b is defined as a long-side end face 14b, and a face included in the closing long-side portion 11c is defined as a long-side end face 14c (see FIG. 6). Further, in the outer circumferential end face 14, a face included in the closing short-side portion 11d is defined as a short-side end face 14d, and a face included in the closing short-side portion 11e is defined as a short-side end face 14e (see FIG. 5). Further, in the outer circumferential end face 14, a face included in the closing corner portion 11f is defined as a corner-portion end face 14f, a face included in the closing corner portion 11g is defined as a corner-portion end face 14g, a face included in the closing corner portion 11h is defined as a corner-portion end face 14h, and a face included in the closing corner portion 11i is defined as a corner portion end face 14i (see FIG. 4). The long-side end faces 14b and 14c, the short-side end faces 14d and 14e, and the corner-portion end faces 14f, 14g, 14h, and 14i are all surfaces extending in the thickwise direction DT (an upper and lower direction in FIG. 4 to FIG. 6) of the closing plate 10.

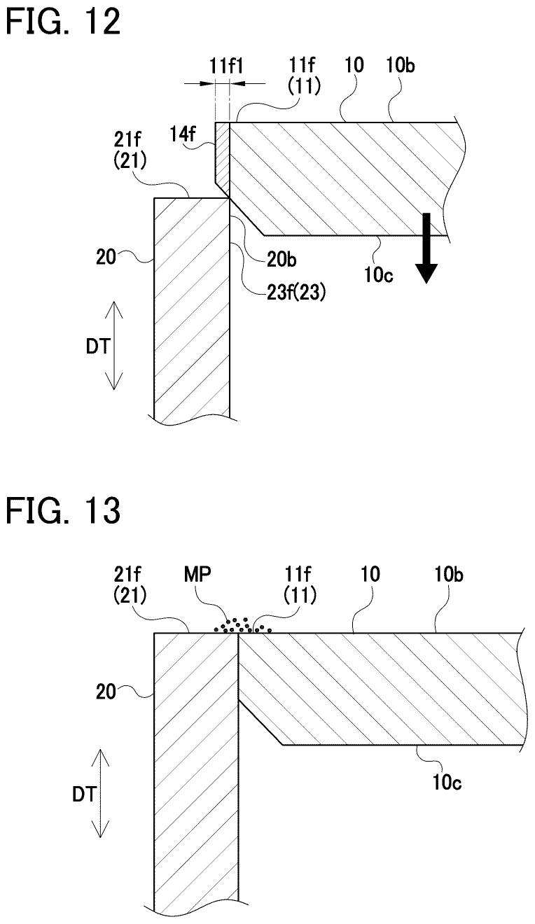

Further, in the present embodiment, the case 20 and the closing plate 10 have a dimensional relation such that at least any one of the closing corner portions 11f, 11g, 11h, and 11i of the closing plate 10 can be overlapped in the thickwise direction DT on at least any one of the opening corner portions 21f, 21g, 21h, and 21i of the case 20 when the closing plate 10 is to be inserted into the opening 20b of the case 20 in the closing process. To be more specific, a relation of the case 20 and the closing plate 10 is defined such that at least any one of the opening corner portions 21f, 21g, 21h, and 21i and at least any one of the closing corner portions 11f, 11g, 11h, and 11i may be overlapped in the thickwise direction due to a difference in dimensions within a range of dimensional tolerance of an outer radius R1 of the closing corner portions 11f, 11g, 11h, and 11i and an inner radius R2 of the opening corner portions 21f, 21g, 21h, and 21i (see FIG. 11 and FIG. 12).

The closing process of the present embodiment is explained in detail. The explanation is made with exemplifying a case where the closing corner portion 11f of the closing plate 10 is overlapped in the thickwise direction DT on the opening corner portion 21f of the case 20 when the closing plate 10 is to be inserted into the opening 20b of the case 20 in the closing process. As shown in FIG. 9, the electrode body 50 integrated with the lid structure 100 is firstly housed in the case 20 through the opening 20b. Then, the closing plate 10 configuring the lid structure 100 is inserted in the opening 20b (in other words, inside the opening wall portion 21) of the case 20 to close the opening 20b of the case 20.

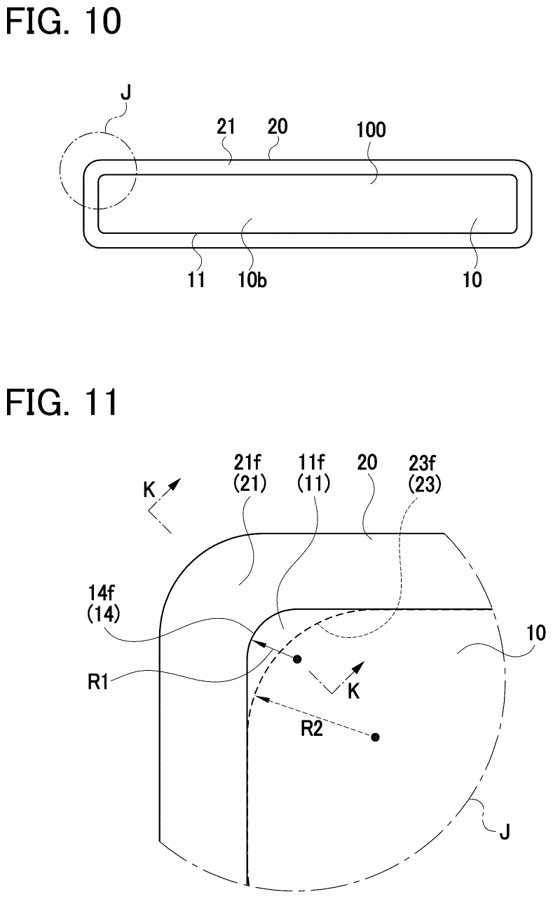

FIG. 10 is a view showing a positional relation of the closing plate 10 and the case 20 when the closing plate 10 has been inserted in the opening 20b of the case 20 as a plan view when seen from a front face 10b side of the closing plate 10. FIG. 11 is an enlarged view of a part J in FIG. 10, illustrating a positional relation of the closing corner portion 11f of the closing plate 10 and the opening corner portion 21f of the case 20 when the closing plate 10 has been inserted in the opening 20b of the case 20. As shown in FIG. 11, this example provides a dimensional relation of the outer radius R1 of the closing corner portion 11f of the closing plate 10 smaller than the inner radius R2 of the opening corner portion 21f of the case 20. Herein, the inner radius R2 of the opening corner portion 21f is a radius of an arcuate circle of a corner-portion inner peripheral surface 23f that is included in the opening corner portion 21f of an inner peripheral surface 23 of the opening wall portion 21 in planar view. Further, the outer radius R1 of the closing corner portion 11f is a radius of an arcuate circle of a corner end face 14f that is included in the closing corner portion 11f of the outer circumferential end face 14 of the closing plate 10 in planar view.

Accordingly, as shown in FIG. 12, the closing plate 10 is inserted into the opening 20b of the case 20 such that a part of the closing corner portion 11f of the closing plate 10 is overlapped in the thickwise direction DT (an upper and lower direction in FIG. 12) on the opening corner portion 21f of the case 20 in the closing process. Thus, there is occurred a “shaving” on the closing corner portion 11f of the closing plate 10 when the closing plate 10 is inserted into the opening 20b of the case 20.

Herein, the “shaving” of the closing corner portion 11f represents a shaven state of a part (specifically, an overlapped portion 11f1 as a portion overlapped in the thickwise direction DT on the opening corner portion 21f of the case 20) of the closing corner portion 11f of the closing plate 10 by insertion of the closing plate 10 into the opening 20b of the case 20 such that a part of the closing corner portion 11f of the closing plate 10 is overlapped in the thickwise direction DT on the opening corner portion 21f of the case 20. As shown in FIG. 13, the overlapped portion 11f1 of the closing corner portion 11f is shaven to turn the metal powder MP, and this metal powder MP is piled on the surface of the closing corner portion 11f and on the surface of the opening corner portion 21f.

The opening corner portions 21f, 21g, 21h, and 21i of the case 20 are harder to be elastically deformed than the opening long-side portions 21b and 21c and the opening short-side portions 21d and 21e. Accordingly, when the closing plate 10 starts to be inserted in the opening 20b of the case 20 in a positional relation shown in FIG. 12, namely, in a positional relation where a part of the closing corner portion 11f of the closing plate 10 is overlapped in the thickwise direction DT on the opening corner portion 21f of the case 20, the opening corner portion 21f is not elastically deformed to outside (namely, on a left side in FIG. 12) along the closing corner portion 11f. As a result of this, the closing plate 10 is being inserted into the opening 20b of the case 20 while the overlapped portion 11f1 of the closing corner portion 11f of the closing plate 10 is being shaven by the opening corner portion 21f of the case 20.

Herein, the metal powder MP generated by shaving of the closing corner portion 11f is piled on the surface of the closing corner portion 11f and on the surface of the opening corner portion 21f (see FIG. 13). Accordingly, when the outer peripheral edge portion 11 of the closing plate 10 and the opening wall portion 21 of the case 20 are laser-welded over the entire circumferences in the welding process after the closing process, there could be occurred spatters and voids due to this metal powder MP.

To address the above, in the present embodiment, the closing plate 10 used for the closing process is configured such that a length LK in the thickwise direction DT of the respective corner-portion end faces 14f, 14g, 14h, and 14i included in the respective closing corner portions 11f, 11g, 11h, and 11i of the outer circumferential end face 14 is made to be shorter than a length LL in the thickwise direction DT of the respective long-side end faces 14b and 14c included in the respective closing long-side portions 11b and 11c. In other words, a relation of LK<LL is satisfied (see FIG. 4 and FIG. 6).

To be more specific, the closing plate 10 used in the closing process includes the front face 10b facing one side in the thickwise direction DT and the rear face 10c facing the other side, and the rear face 10c side of the outer peripheral edge portion 11 is C-chamfered over the entire circumference to form the chamfered portion 15. The chamfered portion 15 includes long-side chamfered portions 15b and 15c included in the closing long-side portions 11b and 11c, short-side chamfered portions 15d and 15e included in the closing short-side portions 11d and 11e, and corner chamfered portions 15f, 15g, 15h, and 15i included in the closing corner portions 11f, 11g, 11h, and 11i (see FIG. 4 to FIG. 6).

The closing corner portions 11f, 11g, 11h, and 11i are more largely chamfered than the closing long-side portions 11b and 11c to make the length LK shorter than the length LL. To be more specific, when a thickness T of the closing plate 10 is set as T=1.4 mm, for example, a chamfered dimension ML (namely, a dimension of the long-side chamfered portions 15b and 15c) of the closing long-side portions 11b and 11c is set as “C0.3”. Further, a chamfered dimension MK (namely, a dimension of the corner chamfered portions 15f, 15g, 15h, and 15i) of the closing corner portions 11f, 11g, 11h, and 11i is set as “C0.7”. According to this arrangement, the length LL is set as LL=1.1 mm while the length LK is set as LK=0.7 mm, thus satisfying the relation of LK<LL.

An example of the Japanese Patent Application Publication No. 2012-079476 as a conventional art also discloses chamfering over the entire circumference on a portion located on the rear face side of the outer peripheral edge portion of the closing plate. Specifically, a portion located on the rear face side of the outer peripheral edge portion of the closing plate is chamfered over the entire circumference at a constant chamfering dimension. In detail, when the thickness T of the closing plate is set as T=1.4 mm, the chamfering dimension of the closing long-side portions, the closing short-side portions, and the closing corner portions are all set as C0.3. Consequently, the conventional art is configured to satisfy the relation of LK=LL=1.1 mm.

As mentioned above, in the present embodiment, the shaven amount of the closing corner portions 11f, 11g, 11h, and 11i can be reduced as compared with the above-mentioned conventional art even when there is occurred the “shaving” on the closing corner portions 11f, 11g, 11h, and 11i of the closing plate 10 in inserting the closing plate 10 into the opening 20b of the case 20 from the rear face 10c side (namely, from a side that has been C-chamfered) in the closing process. Herein, the shaven amount of the closing corner portions 11f, 11g, 11h, and 11i represents a volume of a shaven portion of the closing corner portions 11f, 11g, 11h, and 11i.

In the example shown in FIG. 11 to FIG. 13, an amount of the metal powder MP generated by shaving of the closing corner portion 11f is less than the above-mentioned conventional art, and thus the amount of the metal powder MP piled on the surface of the outer peripheral edge portion 11 of the closing plate 10 and on the surface of the opening wall portion 21 of the case 20 can be reduced. Accordingly, when the outer peripheral edge portion 11 of the closing plate 10 and the opening wall portion 21 of the case 20 are laser-welded over the entire circumferences in the welding process after the closing process, generation of the spatters and the voids due to the metal powder MP can be lessened.

The opening long-side portions 21b and 21c of the case 20 are easier to be elastically deformed than the opening corner portions 21f, 21g, 21h, and 21i. Accordingly, even when insertion of the closing plate 10 into the opening 20b of the case 20 is started in a positional relation where parts of the closing long-side portions 11b and 11c of the closing plate 10 are overlapped in the thickwise direction DT on the opening long-side portions 21b and 21c of the case 20, the opening long-side portions 21b and 21c are elastically deformed outwardly along the closing long-side portions 11b and 11c while the closing long-side portions 11b and 11c are coming to contact with the opening long-side portions 21b and 21c. By this elastic deformation of the opening long-side portions 21b and 21c, the closing plate 10 is being inserted in the opening 20b of the case 20 in a manner that the closing long-side portions 11b and 11c are free from being overlapped in the thickwise direction DT on the opening long-side portions 21b and 21c. Consequently, shaving of the closing long-side portions 11b and 11c is restrained.

Further, the opening short-side portions 21d and 21e of the case 20 are also easier to be elastically deformed than the opening corner portions 21f, 21g, 21h, and 21i. Accordingly, the closing short-side portions 11d and 11e of the closing plate 10 are harder to cause the “shaving” than the closing corner portions 11f, 11g, 11h, and 11i. Herein, the “shaving” in the present embodiment represents a shaven state of the overlapping portion of the outer peripheral edge portion 11 of the closing plate 10 overlapped in the thickwise direction on the opening wall portion 21 by insertion of the closing plate 10 into the opening 20b of the case 20 such that at least a part of the outer peripheral edge portion 11 of the closing plate 10 is overlapped in the thickwise direction DT on at least a part of the opening wall portion 21 of the case 20 in the closing process. This “shaving” generates the metal powder MP, and this metal powder MP is piled on the surface of the outer peripheral edge portion 11 and on the surface of the opening wall portion 21.

However, the opening short-side portions 21d and 21e of the case 20 are harder to be elastically deformed than the opening long-side portions 21b and 21c. Therefore, the closing short-side portions 11d and 11e of the closing plate 10 are easier to cause the “shaving” than the closing long-side portions 11b and 11c.

To address the above, in the present embodiment, the closing plate 10 used for the closing process is arranged such that the length LS in the thickwise direction DT of the respective short-side end faces 14d and 14e included in the closing short-side portions 11d and 11e and the length LL in the thickwise direction DT of the respective long-side end faces 14b and 14c included in the closing long-side portions 11b and 11c satisfy a relation of LS<LL (see FIG. 5 and FIG. 6). In one specific example, when the thickness T of the closing plate 10 is set as T=1.4 mm, a chamfered dimension (namely, a dimension of the long-side chamfered portions 15b and 15c) ML of the closing long-side portions 11b and 11c is set as “C0.3”. Further, a chamfered dimension (namely, a dimension of the short-side chamfered portions 15d and 15e) MS of the closing short-side portions 11d and 11e is set as “C0.5”. The length LL is thus set as LL=1.1 mm, and the length LS is set as LS=0.9 mm, thereby satisfying the relation of LS<LL.

This arrangement achieves reduction in the shaven amount of the closing short-side portions 11d and 11e as compared with the above-mentioned conventional art even when the “shaving” occurs in the closing short-side portions 11d and 11e when the closing plate 10 is inserted in the opening 20b of the case 20 in the closing process. Herein, the shaven amount of the closing short-side portions 11d and 11e represents a shaven volume of the respective closing short-side portions 11d and 11e.

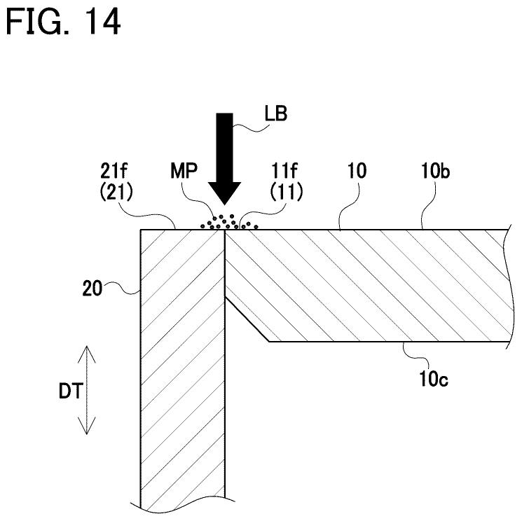

Subsequently, in the welding process, the outer peripheral edge portion 11 of the closing plate 10 and the opening wall portion 21 of the case 20 are laser-welded over their entire circumferences while the opening 20b of the case 20 has been closed by the closing plate 10. Specifically, as shown in FIG. 14, laser beam LB is irradicated on the outer peripheral edge portion 11 of the closing plate 10 and the opening wall portion 21 of the case 20 from the front face 10b side (namely, from an upper side in FIG. 14) of the closing plate 10 to weld the outer peripheral edge portion 11 of the closing plate 10 and the opening wall portion 21 of the case 20. The case 20 and the closing plate 10 are thus joined and integrated.

As mentioned above, in the closing process of the present embodiment, the amount of the metal powder MP piled on the surface of the outer peripheral edge portion 11 of the closing plate 10 and on the surface of the opening wall portion 21 of the case 20 is reduced. Therefore, while the outer peripheral edge portion 11 of the closing plate 10 and the opening wall portion 21 of the case 20 are laser-welded over the entire circumferences, generation of spatters and voids due to the metal powder MP can be lessened.

After welding, an electrolytic solution (not shown) is injected in the case 20 through an injection hole (not shown) formed in the closing plate 10. The injection hole is then sealed, and thus the power storage device 1 is completed.

The present disclosure is explained above with the embodiment, but the present disclosure is not limited to the above-mentioned embodiment and may be applied with any appropriate modifications without departing from the scope of the disclosure.

For example, in the present embodiment, a specific example of the closing plate 10 used for the closing process is arranged to have the thickness T of the closing plate as T=1.4 mm with the length LL=1.1 mm and the length LK=0.7 mm so that the relation of LK<LL is satisfied. However, the present disclosure is not limited to the above example and may be arranged with any dimensions for the length LK and the length LL as long as the relation of LK<LL is satisfied. Further, the thickness T of the closing plate is not limited to 1.4 mm and may be any other thickness dimension.

Further, in the embodiment, a specific example of the closing plate 10 used for the closing process is arranged to have the thickness T of the closing plate 10 as T=1.4 mm with the length LL=1.1 mm and the length LS=0.9 mm so that the relation of LS<LL is satisfied. However, the present disclosure is not limited to the above example and may be arranged with any dimensions for the length LS and the length LL. The present disclosure includes not only the case of satisfying the relation of LS<LL but also a case of satisfying a relation LS=LL and a case of satisfying a relation LS>LL, but satisfying the relation LS≤LL is preferable.

### REFERENCE SIGNS LIST

1 Power storage device
10 Closing plate
11 Outer peripheral edge portion
11b, 11c Closing long-side portion
11d, 11e Closing short-side portion
11f, 11g, 11h, 11i Closing corner portion
13 Outer circumferential surface
14 Outer circumferential end face
14b, 14c Long-side end face
14d, 14e Short-side end face
14f, 14g, 14h, 14i Corner-portion end face
15 Chamfered portion
20 Case
20b Opening
21 Opening wall portion
21b, 21c Opening long-side portion
21d, 21e Opening short-side portion
21f, 21g, 21h, 21i Opening corner portion
50 Electrode body
60 Positive current collecting member
70 Negative current collecting member

What is claimed is:

1. A manufacturing method for a power storage device, which comprises an electrode body, a case made of metal for housing the electrode body, and a closing plate made of metal and formed to be of a rectangular shape, which is to be inserted in a rectangular opening of the case for closing the opening, the power storage device being welded over entire circumferences of an opening wall portion of the case surrounding the opening and an outer peripheral edge portion of the closing plate, wherein
the method includes:
closing to close the opening by the closing plate in a manner that the electrode body is housed inside the case and the closing plate is inserted into the opening of the case; and
welding to laser-weld the outer peripheral edge portion of the closing plate and the opening wall portion of the case over the entire circumferences in a state where the opening of the case has been closed by the closing plate,
the opening wall portion of the case used for the closing is of a rectangular annular shape and includes a pair of opening long-side portions arranged in parallel to each other, a pair of opening short-side portions arranged in parallel to each other, and four opening corner portions of arcuate circular shape connecting the opening long-side portions and the opening short-side portions,
the closing plate used for the closing is configured such that:
the outer peripheral edge portion is of a rectangular annular shape and includes a pair of closing long-side portions arranged in parallel to each other, a pair of closing short-side portions arranged in parallel to each other, and four closing corner portions of arcuate circular shape connecting the closing long-side portions and the closing short-side portions;
an outer circumferential end face positioned on an outermost side of an outer circumferential surface of the closing plate is formed to extend in parallel to a thickwise direction of the closing plate; and
when a length in the thickwise direction of a corner-portion end face included in each of the closing corner portions is represented as LK and a length in the thickwise direction of a long-side end face included in each of the closing long-side portions is represented as LL, the length LK is shorter than the length LL.

2. The manufacturing method for the power storage device according to claim 1, wherein
the closing plate used for the closing is configured such that:
the closing plate has a front face facing one side in the thickwise direction and a rear face facing the other side in the thickwise direction;
a portion located on a rear face side of the outer peripheral edge portion is chamfered over an entire circumference;
the closing corner portions are chamfered more largely than the closing long-side portions to make the length LK shorter than the length LL; and
the closing is to insert the closing plate into the opening of the case from the side of the rear face.

3. The manufacturing method for the power storage device according to claim 1, wherein, when a length in the thickwise direction of a short-side end face included in each of the closing short-side portions in the outer circumferential end face is represented as LS, the closing plate used for the closing satisfies a relation of a length LS and the length LL represented as LS≤LL.

4. The manufacturing method for the power storage device according to claim 2, wherein, when a length in the thickwise direction of a short-side end face included in each of the closing short-side portions in the outer circumferential end face is represented as LS, the closing plate used for the closing satisfies a relation of a length LS and the length LL represented as LS≤LL.
